(19) United States
(12) Patent Application Publication
(10) Pub. No.: US 2006/0101184 A1
(43) Pub. Date: May 11, 2006

(54) Dual speed/dual redundant bus system

(75) Inventor: Michael G Hegarty, Westbury, NY (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Data Device Corporation, Bohemia, NY (US)

(21) Appl. No.: 11/266,979

(22) Filed: Nov. 4, 2005

Related U.S. Application Data
(60) Provisional application No. 60/626,176, filed on Nov. 9, 2004.

(51) Int. Cl. G06F 13/40

(52) U.S. Cl. 710/307

(57) ABSTRACT

Method and apparatus for use of the dual redundant bus network utilizing time and frequency multiplexing techniques to provide a high bit rate system that maintains a lower bit error rate with good fault tolerance by sending a low speed message on one bus and a high speed message on the remaining bus then operating at a dual bus mode and for reducing the speed of the high speed to aerate between the high speed and low speed message rates and multiplexing the low speed and reduced high speed messages when a fault condition is detected on one of the buses. Techniques are provided for continuously monitoring the buses to identify the least recently used (LRU) to facilitate bus selection and selection of one of the dual bus and concurrent modes for operation.

This application claims priority from U.S. provisional application No. 60/626,176 filed on Nov. 9, 2004, which is incorporated by reference as if fully set forth.

### FIELD OF INVENTION

The present invention relates to dual redundant bus systems and more particularly to method and apparatus for maximizing throughput in said bus systems by utilization of both buses while maintaining the fault tolerant features and capabilities of existing low speed dual redundant bus systems.

Methods and apparatus are provided for implementing a bus system such as a High Performance 1553 (HP-1553) system consisting of a legacy MIL-STD-1553 network (including cable, couplers, and terminals) with new High Performance 1553 terminals operating concurrently with the legacy MIL-STD-1553 (MS-1553) terminals. The HP-1553 terminals transfer data at rates beyond the 1 Mbps limit of MIL-STD-1553.

The dual standby redundant architecture of MIL-STD-1553 is used to implement a system having a new high speed communication channel and which maintains all of the architectural benefits of the legacy system such as redundancy, fault tolerance, and low bit error rate (BER). A major benefit of the present invention is that the new high speed communication channels are established without adding new cabling to the platform or modifying existing terminals on legacy 1553 buses. The new high speed communication channels are implemented over existing MIL-STD-1553 (MS-1553) networks and are completely transparent to legacy MS-1553 terminals.

Higher bit rates than conventional MS-1553 are achieved by a combination of time and frequency division multiplexing between MS-1553 and HP-1553 waveforms across redundant channels. One of the redundant buses is designated as the primary channel for MS-1553 and the other redundant bus as the primary communication channel for HP-1553, thus separating the waveforms and providing the optimal signal-to-noise ratio (SNR). In response to errors, both MS-1553 and HP-1553 coexist on the same bus. Methods employed for error handling and fault tolerance maximize bit rates while maintaining high reliability communication.

### BACKGROUND

MIL-STD-1553 (MS-1553) defines a 1 megabit per second (Mbps) multi-drop serial data bus that has been used as the predominant data communication bus in military aircraft, precision guided munitions, ground based military vehicles, and naval shipboard applications for the past 30 years. MS-1553 still satisfies the command and control requirements of a vast number of applications. However, there are emerging systems that require higher data rates in addition to 1 megabit per second (1 Mbps) MIL-STD-1553.

A typical MIL-STD-1553 network contains available capacity well beyond that required to implement the legacy 1 Mbps data communication interface. Various research activities have revealed that a typical 1553 network contains several hundred megabits of available capacity. It is proposed that high bandwidth communication could coexist with legacy MIL-STD-1553.

In theory, a 1 Mbps MIL-STD-1553 signal could be implemented using 2 MHz of bandwidth (based on a 1 MHz base band signal). Unfortunately, legacy MIL-STD-1553 signals are not band limited and contain harmonic content extending beyond 10 MHz and in some cases beyond 30 MHz. The large harmonic content in a 1553 waveform creates noise in frequency bands that could otherwise be used to implement higher speed data communication concurrent with the MIL-STD-1553 traffic.

The insertion loss of a MIL-STD-1553 network increases as a function of frequency beyond the 1 MHz pass band defined in MIL-STD-1553. One possible implementation of a high performance 1553 system would be implement the high bandwidth signal in the frequency band above the 1 MHz 1553 pass band. The high frequency loss of the network makes it desirable to implement the high bandwidth signal in frequency bands as low as possible (i.e. close to but not overlapping the MS-1553 pass band) to minimize signal loss. The problem with utilizing the frequency band close to MS-1553 is that harmonics of the MS-1553 waveform introduce significant noise in this higher frequency band.

The optimal implementation is to eliminate the MS-1553 induced noise and utilize the band close to the MS-1553 pass band, providing the lowest signal attenuation with a low noise level. The challenge is finding a way to reduce the MS-1553 noise above 2 MHz. One approach is to install a low pass filter on the legacy MS-1553 terminals. The logistics and high cost of installing filters makes it an unattractive solution. An alternative solution is to partition the communication such that MS-1553 uses one of the redundant buses while HP-1553 uses the other bus. The challenge in implementing this partitioning is maintaining the fault tolerant features of 1553. The present invention provides a methodology and apparatus that preserves the fault tolerant features of MS-1553 and extends them to HP-1553.

MIL-STD-1553 Standby Redundancy

MIL-STD-1553 defines a dual standby redundant interface which consists of two buses: a primary bus and a secondary bus, see FIG. 1. Each terminal T₁-T_{N} on the network 10 has independent connections to both the primary and secondary buses. See primary bus connections C_{P1}-C_{PN} and secondary bus connections C_{S1}-C_{SN}. The primary bus is typically used exclusively for normal communication (i.e. when no errors occur). The secondary bus is used for communication when errors/faults occur on the primary bus.

FIG. 1A shows the dual redundant bus of FIG. 1 in greater detail wherein each terminal T₁-T_{N} is coupled to a primary bus and a secondary bus. Both the primary bus and secondary bus are each made up of twisted-shielded pairs of wires to maintain message integrity. The twisted wire buses are each terminated with impedances Z₀. Each of the terminal electronics T₁-T_{N} is coupled to each bus using either a “direct coupled” connection or a “transformer coupled” connection. A transformer coupled connection (illustrated for the T₁ terminal in FIG. 1A) includes an isolation transformer (which is part of the terminal), a section of a twisted wire pair TW (recommended limit in MIL-STD-1553 is 20 feet), a coupling transformer, and a pair of series isolation resistors. A direct coupled connection (illustrated for the T₂ terminal in FIG. 1A) includes an isolation transformer and a pair of series isolation resistors (located within the terminal), and a short length of twisted wire pair TW (recommended limit in MIL-STD-1553 is 1 foot). A MIL-STD-1553 network may include a mixture of direct and transformer coupled connections.

All transmissions on the MIL-STD-1553 network are initiated by a conventional bus controller (BC). The BC may be implemented in any one of the terminals T₁-T_{N} located on the MIL-STD-1553 bus (the figures do not differentiate between BC and RT terminals for purposes of simplicity since the BC/RT mode is a logical function and is not dependent on the physical topology of the network). Each remote terminal T₁-T_{N} is required to monitor both the primary and secondary buses waiting for a command from the BC. A remote terminal T may not transmit on a 1553 bus until it receives a command from the BC instructing it to do so, as is conventional. There is only one BC on a MIL-STD-1553 bus. The MIL-STD-1553 BC may only transmit on either the primary or the secondary bus. The bus controller may not transmit on both primary and secondary buses simultaneously. This implies that at any given point in time, at least one of the 1553 buses will have no activity.

Concurrent MS and HP 1553

Measurement, analysis, modeling, and experiments have shown that it is possible to transmit a high speed signal concurrently with a MIL-STD-1553 signal such that the high speed signal does not interfere with the MIL-STD-1553 signal in the frequency band of interest to legacy 1553 equipment. It has also been shown that this high frequency signal can be sent through a typical 1553 network and be successfully decoded by a high performance (HP) 1553 receiver. It has been found that the large harmonic content of the legacy 1 Mbps 1553 signal appears as a large noise signal to the HP 1553 receiver and thus reduces the signal-to-noise ratio (SNR) of the high performance (HP) 1553 signal.

The power level of the HP 1553 signal is limited by a requirement for the system to comply with the EMI emissions limits defined in MIL-STD-461. The limited signal level combined with the large noise level (high frequency harmonic content of the MIL-STD-1553 waveforms) defines the capacity of the HP 1553 network. The capacity, and in turn the effective bit rate of the system are increased significantly if the legacy MIL-STD-1553 waveforms are not present.

### BRIEF DESCRIPTION OF THE INVENTION

The present invention provides a system implementation and method that exploits the inherent feature that the legacy MIL-STD-1553 terminals only transmit on one of the dual redundant buses at any given time. The high performance 1553 system combines time and frequency multiplexing techniques to deliver a high bit rate system that maintains a low bit error rate with good fault tolerance. The basic operation of the system is that normal MIL-STD-1553 communication occurs on the bus designated as the primary bus while HP 1553 communication occurs on the secondary bus. The potential bit rate of the HP 1553 communication may be higher based on the assumption that MIL-STD-1553 traffic (and its high frequency harmonics) is not present on the secondary bus.

Two modes of operation are defined: i.e., dual bus mode and concurrent mode. The present invention separates MS-1553 and HS-1553 onto alternate buses, allowing the HP-1553 communication to operate at higher data rates. The presence of a fault condition on one of the buses alters operation of the both MS-1553 and HP-1553 to operate concurrently on the same bus (either primary or secondary). This concurrent mode is considered a degraded mode of operation because the MS-1553 traffic will induce noise within the HP-1553 frequency band, thus reducing the SNR and limited the potential bit rate.

### BRIEF DESCRIPTION OF THE DRAWINGS

FIG. 1 is a simplified block diagram showing a typical dual redundant MIL-STD-1553 network.

FIG. 1A shows the network of FIG. 1 in greater detail.

FIG. 2 is a simplified block diagram showing a high performance error-free 1553 primary dual bus mode operating in accordance with the principles of the present invention.

FIG. 3 is a simplified block diagram of a concurrent primary bus mode operating in accordance with the principles of the present invention and having a faulted secondary bus condition.

FIG. 3A is a simplified block diagram showing the manner in which MS-1553 and HP-1553 transmitters are multiplexed.

FIG. 3B shows the frequency spectrums of the MS-1553 and HP-1553 signals.

FIG. 4 is a state diagram showing the basic operation of a type 1553 dual redundant bus and embodying the principles of the present invention.

FIG. 4A is a simplified block diagram of an HP-1553 transmitter.

FIG. 4B shows the components of an HP-1553 transmission.

FIG. 5 is a state diagram showing the procedure for selecting a bus for high speed transmission.

FIG. 6 is a state diagram showing the procedure for high speed retries on a dual redundant bus.

FIG. 7 is a state diagram showing the procedure for concurrent mode transmission on a dual redundant bus.

FIG. 8 is a state diagram combining the procedures shown in FIGS. 6 and 7 into a single state diagram.

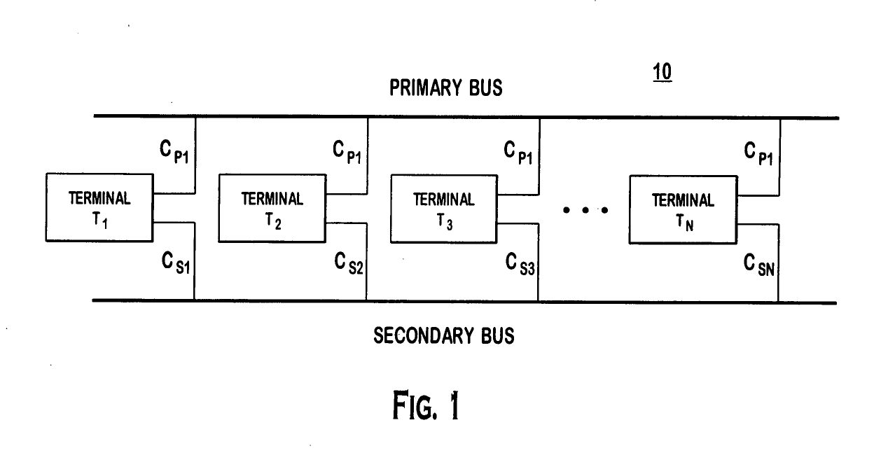

### DETAILED DESCRIPTION OF THE PREFERRED EMBODIMENT(S)

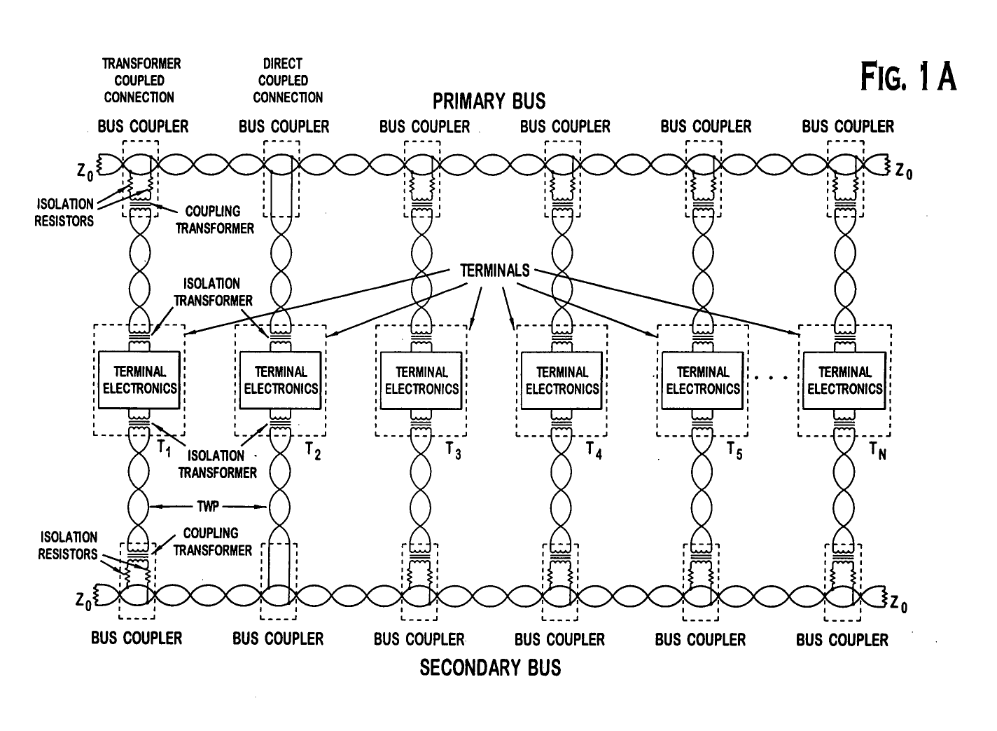

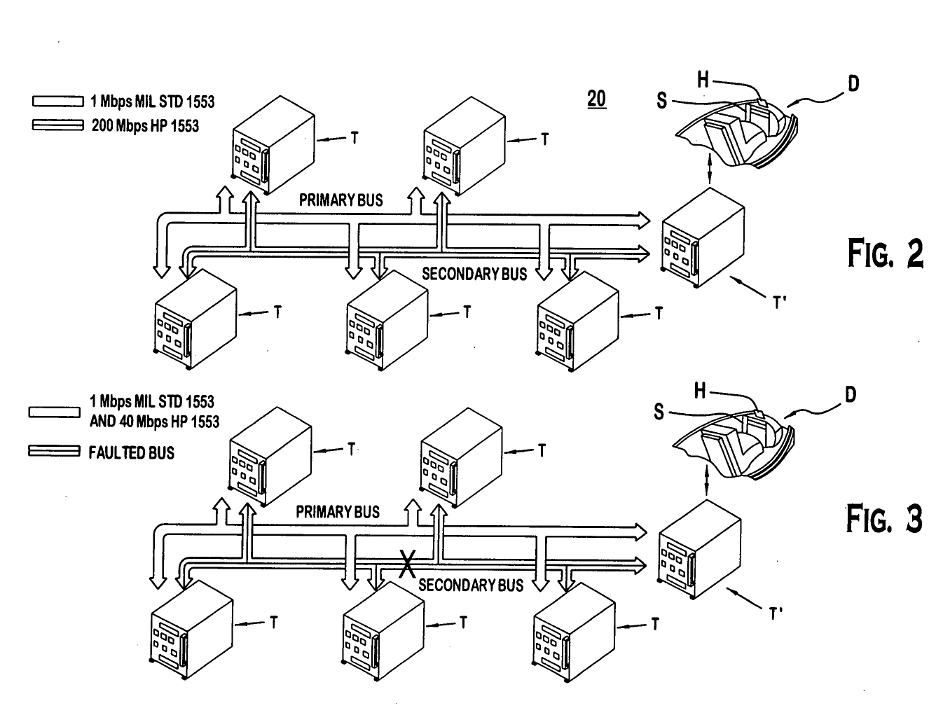

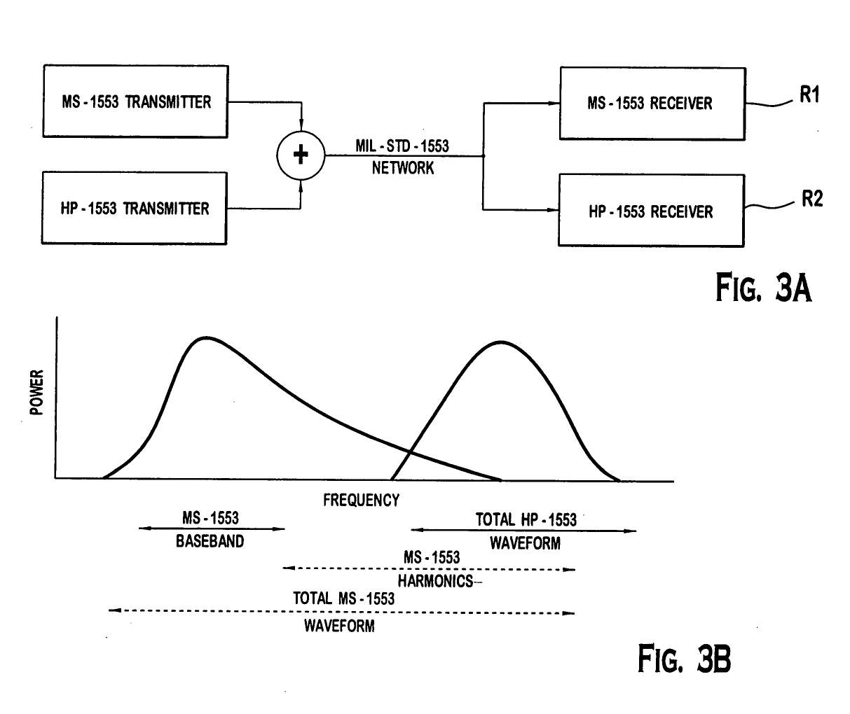

FIG. 2 illustrates an HP 1553 system 20 in which 1 Mbps MIL-STD-1553 communication occurs on the primary bus and higher speed (such as 200 Mbps) high performance 1553 communication occurs on the secondary bus. It should be noted that the speed of the high performance 1553 communication is arbitrary with regard to the concepts described herein. 200 Mbps has been chosen only for illustrative and not limiting purposes. The mode of operation, in which the 1 Mbps traffic is on the primary bus and the 200 Mbps high performance 1553 traffic is on the secondary bus, is referred herein to as “primary dual bus” mode. Conversely, the mode of operation in which the 200 Mbps HP-1553 traffic is on the primary bus and the 1 Mbps MS-1553 traffic is on the secondary bus is referred to herein as “secondary dual bus” mode. Terminals T are capable of communicating with both the primary and secondary buses. The system 20 is capable of serving a variety of applications. For example, system 20 may be employed in a large aircraft. The right-hand-most terminal T′ may be coupled to a cockpit display D in the aircraft, display D being provided, for example, with a split screen S and a heads-up display H. A similar system is shown in FIG. 3.

While operating in the dual bus mode, the 200 Mbps HP-1553 waveform is implemented such that it is compatible with a 1 Mbps MS-1553 system. i.e. the 200 Mbps HP-1553 waveform does not contain frequency components within the MS-1553 pass band. In effect the 1 Mbps MS-1553 and 200 Mbps HP-1553 frequency division multiplying signals are frequency division multiplexed. It should be noted that the signals are loosely frequency multiplexed because an MS-1553 waveform is not band limited and thus would have harmonic content that may overlap with the frequency band of the HP-1553 waveform. This interference is not a detriment during dual bus operation since the waveforms do not appear simultaneously on the same bus. However, the interference will affect the HP-1553 terminals when the MS-1553 bus controller makes use of the secondary bus when a fault condition exists or an error occurs. The possible occurrence of MS-1553 traffic problems (due to errors on the primary bus) creates the need for alternate modes of operation during these conditions.

Concurrent Modes

When a fault condition exists on the secondary bus it becomes necessary for the MS-1553 and HP-1553 signals to share the primary bus in what will be referred to as the “concurrent primary bus” mode, refer to FIG. 3. Conversely when a fault condition exists on the primary bus it becomes necessary for the MS-1553 and HP-1553 signals to co-exist on the secondary bus in what will be referred to as the “concurrent secondary bus” mode.

While operating in either the concurrent primary bus or concurrent secondary bus mode the MS-1553 and HP-1553 are frequency division multiplexed FIG. 3A is a simplified block diagram and FIG. 3B is a chart illustrating the frequency spectrums of the MS and HP 1553 waveforms. As was discussed earlier, the high frequency harmonics of the MS-1553 signal may appear as noise to the HP-1553 signal and thus reduce the SNR. The reduced SNR will result in a lower achievable bit rate. As one practical example it is assumed that 40 Mbps is a reasonable data rate for the HP-1553 signal in the presence of MS-1553 harmonic noise. This lower HP-1553 signal rate will be referred to as the “concurrent speed” (40 Mbps) as opposed to the “higher speed” (200 Mbps).

Dual Bus Operation

As described above there are various modes of operation which allow for simultaneous MS-1553 and HP-1553 communication at varying data rates (depending on the mode). The goal of the system is to allow the HP-1553 communication to operate at its highest rate (200 Mbps) which requires exclusive use of one of the redundant buses. The following describes a method of and apparatus for operation of the HP-1553 terminals that will provide a 200 Mbps data rate under normal operating conditions and a degraded 40 Mbps in the presence of a hard failure on one of the buses. In addition several fault recovery algorithms are provided.

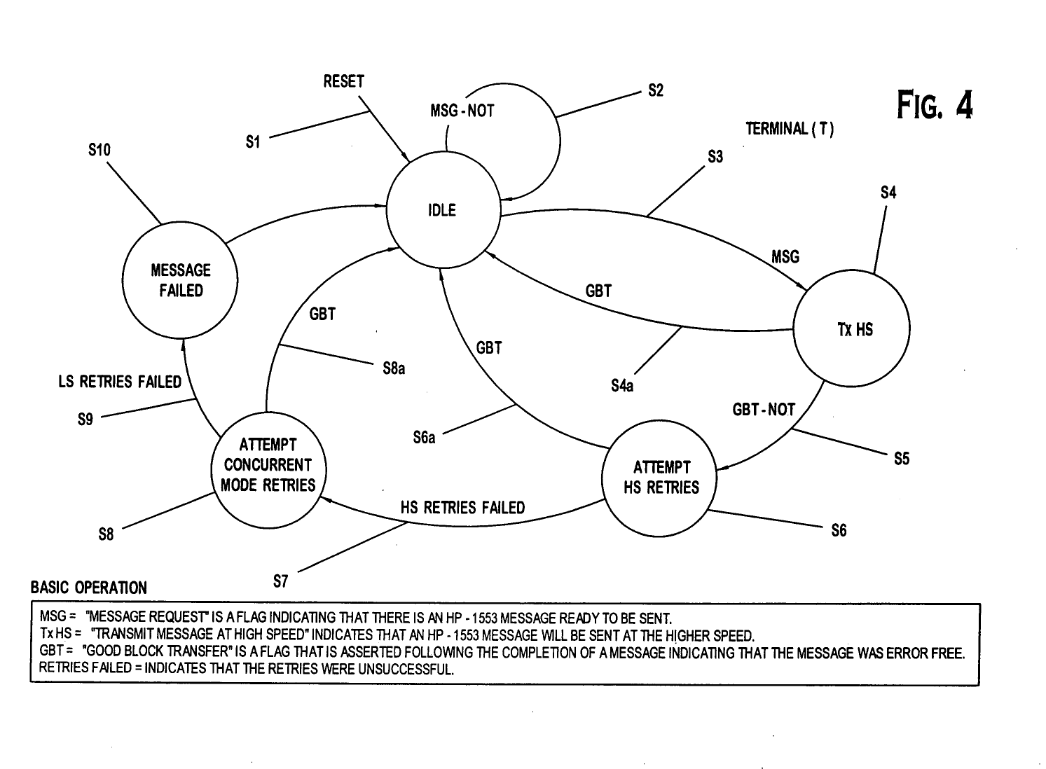

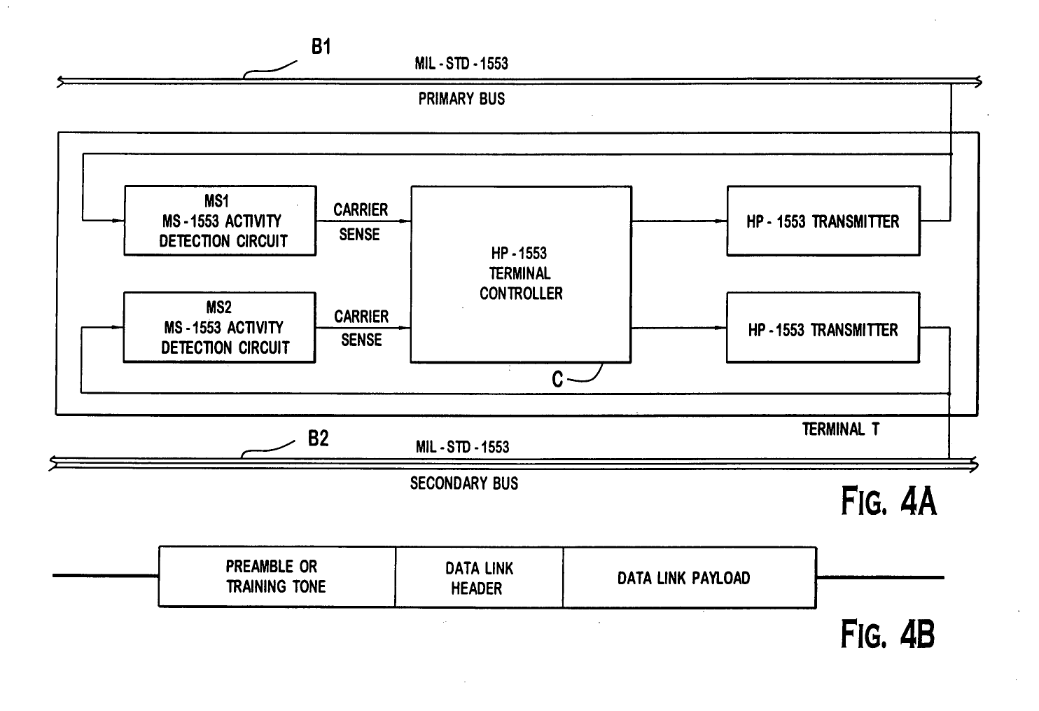

The basic operation of the HP-1553 system is summarized in the state diagram shown in FIG. 4. The HP-1553 terminal T is initially reset at step S1 and remains in the idle state, step S2, when no message is being sent. The HP-1553 terminal at step S3, has a message (MSG) to send and attempts to transmit the message at the higher speed (200 Mbps), at step S4 (Tₓ Hₛ). If the message is successful, at step S4a, the terminal returns to the idle state in readiness for the next message. If the message is unsuccessful, at step S5 (GBT-Not) then the HP-1553 terminal, at step S6, attempts a number of retries at the higher speed on the primary and/or secondary buses (based on rules that will be described later). If the high speed retries are unsuccessful, at step S7, then the terminal attempts to retry the message at the concurrent mode data rate (40 Mbps), together with the MS-1553 message, on one of the primary and secondary buses, at step S8. If the concurrent mode retries are unsuccessful, step S9, it is assumed that there exists a hard failure in the system, at step S10. When either the high retry speed attempt is successful, step S6a, or when the concurrent mode attempt is successful, step S8a, terminal T returns to the idle state in readiness for the next message.

It is assumed that the HP-1553 terminals will have no apriori knowledge of MS-1553 traffic. The HP-1553 terminals are thus each implemented with an MS-1553 activity monitor on the primary and secondary buses to detect the presence of MS-1553 traffic (MS-1553 Carrier Sense). As shown in FIG. 4A each sensor MS1, MS2 of terminal T is configured to respectively monitor an associated one of the buses B1, B2 to detect the presence of the MS-1553 carrier frequency. The presence of MS-1553 traffic is provided to a controller C which is configured to make a bus selection (for selecting which bus will be used for MS-1553 Transmission) and error handling decisions. The HP-1553 terminal controller C for each terminal also keeps track of which bus (primary or secondary) the last 1553 transmission occurred on in an effort to provide a mechanism of determining which of the buses has been least recently used (LRU). The least recently used (LRU) bus will be a criterion in the transmission and retry algorithms.

The default (i.e. “normal”) mode of operation for the High Performance 1553 system is the Primary Dual Bus mode, in which the MS-1553 bus controller utilizes the primary bus and the HP-1553 communication is occurring at high speed (200 Mbps) on the secondary bus.

Each HP-1553 terminal is configured to operate at 200 Mbps on the secondary bus (again the bit rates presented herein are for relative comparison and are not absolute values). Configuring the terminals may involve a training, tuning, or negotiation process between HP-1553 terminals. The training may be done once as part of the system installation, at system power-up, during system initialization, periodically, or on every message. The exact training requirements are dependent on the modulation scheme and implementation used for the HP-1553 signal. FIG. 4B illustrates an example of a modulated signal consisting of a training tone (or preamble) followed by a data link header and data payload.

FIG. 4B illustrates an example of an HP-1553 communication packet which consists of a preamble, a data link header, and a data link payload. The preamble (also referred to as a training tone) is used by the receiver, for example see R1, R2 in FIG. 3A, to synchronize the receiver clock to the transmitter's clock (clock recovery), and to calibrate the receiver to compensate for distortion induced by the network.

MS-1553 communication will occur on the primary bus and 200 Mbps HP-1553 communication will occur on the secondary bus. The MS-1553 activity monitors of the terminal T actively monitor both primary and secondary buses providing an MS-1553 Carrier Sense status and maintain an indication of which bus the last 1553 transmission was on, see FIG. 4A.

It is a primary goal of the HP-1553 terminal that the HP-1553 transmission not occur on the same bus as an MS-1553 transmission. There is no way to accurately predict the future activities of the MS-1553 bus controller (BC) since it operates independently and asynchronously from the HP-1553 terminals. The HP-1553 terminal utilizes a Least Recently Used (LRU) algorithm in selecting which bus to transmit on (primary or secondary). The rationale for LRU is the assumption that past transmissions are the best predictions of future events, i.e., if the MS-1553 bus controller used the primary bus for the last message it sent, there is a higher probability that it will use the primary bus again for future messages. This assertion is supported by the assumption that the secondary bus is only used by the MS-1553 bus controller for error handling in the event of communication problems on the primary bus.

The Least Recently Used (LRU) bus is determined as the opposite of the bus carrying the last detected MS-1553 transmission. It is expected that the MS-1553 bus controller will utilize the primary bus, in which case the last detected 1553 transmission will be on the primary bus. The LRU requirement would then select the secondary bus as the bus of choice for the HP-1553 transmission.

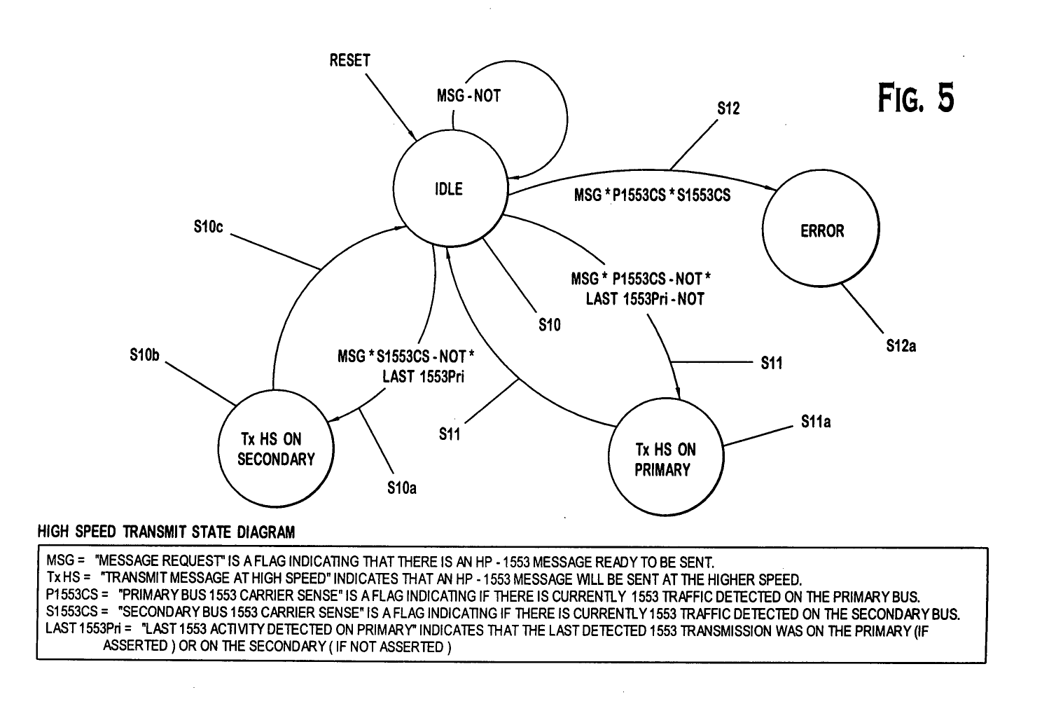

The HP-1553 high speed transmission algorithm, performed by controller C, is illustrated in the state diagram shown in FIG. 5 and is summarized as follows, assuming detection of the conditions on the primary and secondary buses are examined when the terminal T is idle, step S10:

If MS-1553 Carrier Sense (1553 CS) is not asserted on the secondary bus (i.e. the secondary bus is idle) and the primary bus was the last bus transmitted on by MS-1553, step S10a then the HP-1553 terminal utilizes the secondary bus at the higher speed (200 Mbps) by default, step S10b and returns to idle after transmission (Tx), step S10c.

If MS-1553 Carrier Sense (1553 CS) is not asserted on the primary bus and the secondary bus was the last bus transmitted on by MS-1553 then the HP-1553, step S11, terminal T utilizes the primary bus at the higher speed (200 Mbps) by default, step S11a and returns to idle, step 11b.

If MS-1553 activity is detected on both primary and secondary buses, step S12, then a fault condition exists, S12a (the MS-1553 bus controller is violating MIL-STD-1553 which precludes the bus controller (BC) from transmitting on both buses). This condition implies that the HP-1553 terminals should switch to the concurrent mode to coexist with MS-1553. Switching to the concurrent mode will require dropping the bit rate to the degraded speed (40 Mbps) to achieve a satisfactory BER. The high speed message transfer is deemed to have failed and the HP-1553 terminal will attempt to retry the message at the concurrent mode bit rate (40 Mbps). It should be understood that the conditions encountered in FIG. 5 occur in an uncertain or random order and the numeric chronological labeling of the steps as S10-S12 are merely for identifying the conditions. Message retries are discussed below.

It should be noted that if there is no MS-1553 activity on the secondary when the HP-1553 transmission begins, there is no guarantee that MS-1553 activity will not occur during the HP-1553 message (MS-1553 does not arbitrate with HP-1553 for access to the buses). The MS-1553 activity monitor is used to estimate which of the buses has a higher probability of a non-concurrent transmission (i.e. a higher probability of success). If an error is detected on an HP-1553 message then the state of the bus needs to be reassessed to determine the best error recovery method.

Error Recovery

When the MS-1553 bus controller utilizes the same bus as the HP-1553 terminal there is an increased probability that the HP-1553 message will experience errors due to noise induced by high frequency harmonics of the MS-1553 waveform. When an HP-1553 terminal detects an error, there are several possible error recovery scenarios: The HP-1553 terminal retries the message on the same bus (secondary) at high speed (200 Mbps); The HP-1553 terminal retries the message on the alternate bus (primary) at high speed (200 Mbps); The HP-1553 terminal retries the message on the same bus (secondary) at the concurrent mode bit rate (40 Mbps); or the HP-1553 terminal retries the message on the alternate bus (primary) at the concurrent mode bit rate (40 Mbps). It should be noted that switching speeds (higher speed to the lower concurrent speed or vice versa) may require time to retrain the receivers depending on the modulation scheme that is utilized. It is assumed that the bit rate can be changed by each terminal T on the fly with minimal overhead. This is accomplished by providing information in the preamble (training tone) that identifies the transmission rate, as shown in FIG. 4B.

The preamble illustrated in FIG. 4B is implemented such that it identifies the transmit bit rate to the receiver (i.e. concurrent speed or higher speed). The receiver utilizes information contained within the preamble to decide whether to decode the received waveform as a concurrent speed transmission or a higher speed transmission. The use of the preamble to communicate the transmission bit rate allows bit rate to be changed dynamically on a frame by frame basis.

The optimal error recovery method will depend on the cause of the error, the condition of the bus network, current MS-1553 activity and the future MS-1553 activity. MS-1553 activity has a significant impact on the performance of HP-1553 since the presence of an MS-1553 message greatly increases the noise level and in turn the probability of an HP-1553 bit error. If the MS-1553 bus controller is using the secondary bus for an extended period of time, the HP-1553 system will achieve better performance by using the primary bus at the higher speed (200 Mbps) or using the secondary at the concurrent mode bit rate (40 Mbps).

When an HP-1553 terminal detects an error in a message, it has the option of retrying the message. It should be noted that not every message may need to be retried. The decision to retry a message is based on the type of data and system requirements. The retry scheme described herein provides flexibility on a message by message basis to program various degrees of retries.

This first type of retry that is attempted is a high speed retry. The principle decision on high speed retries is which bus should the retry be attempted on (primary or secondary). This decision needs to consider the impact of MS-1553 traffic and the possibility of a hard failure on one of the buses. The basic retry scheme uses a least recently used (LRU) algorithm which assumes that the bus that has been idle (in terms of MS-1553 activity) for the longest period of time is the most likely to remain idle, i.e., if the MS-1553 bus controller has been using the primary bus, it will most likely continue to use the primary bus.

The LRU algorithm selects a bus on which to transmit that has a low probability of colliding with MS-1553 traffic. The LRU algorithm does not address the possibility of a hard failure on one of the buses. For example, consider the case illustrated in FIG. 3 in which the secondary bus has a hard fault (such as an open circuit or short circuit in the bus cable). The secondary bus will be the least recently used bus. It can be assumed that the MS-1553 bus controller is not going to use the secondary bus due to the fact that the primary is the default MS-1553 bus and the existence of a fault on the secondary bus. Continuously retrying the HP-1553 message on the secondary bus will result in errors. To provide the ability to work around this condition the HP-1553 terminal will maintain high speed retry counts for each bus.

The purpose of the high speed retry count is two fold. First it provides a decision mechanism for giving up on the message. Second it can be used to provide an opportunity to issue a retry on the “most” recently used bus in the event of a hard failure. Consider the example of a faulted secondary bus scenario described above, the HP-1553 terminal issues retries on the secondary bus based on the LRU algorithm until the maximum retry count is reached for the secondary bus. Once the maximum retry count for the secondary is reached, the HP-1553 terminal issues a high speed retry on the primary if the primary is not currently active (i.e. there is currently no MS-1553 activity). If there is MS-1553 activity on the primary bus then the HP-1553 terminal has no choice but to retry the message at the concurrent mode bit rate (40 Mbps) to coexist with the MS-1553 traffic.

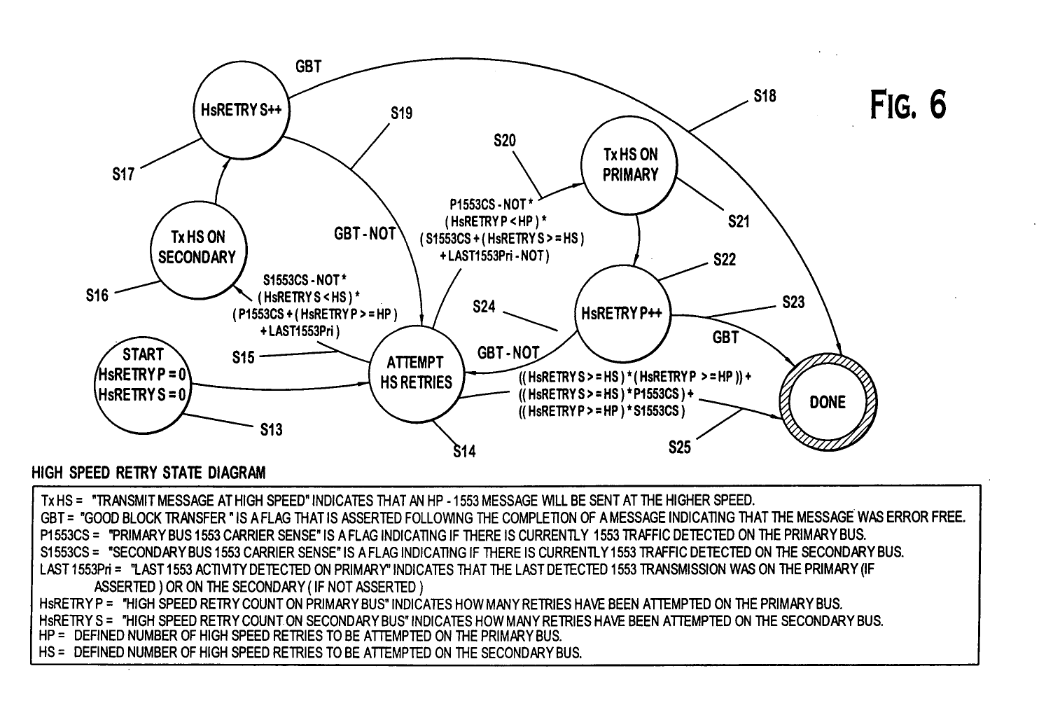

The high speed retry algorithm is illustrated in FIG. 6 and is summarized as follows:
Retry counts for primary and secondary buses are initialized to zero, at step S13.
If one bus is active then the retry will be issued on the opposite bus unless the maximum retry count for that bus has been reached.
If both buses are idle then the retry will be issued on the least recently used bus (in terms of MS-1553 activity) unless the terminal retry count for that bus has been reached.
If both buses are idle and the maximum retry count has been reached on one of the buses then a retry will be attempted on the opposite bus.
Retries will end when a message is successful, or the maximum retry count has been reached for both buses, or the maximum retry count has been reached for one bus and the opposite bus is currently active.

Making reference to FIG. 6 in greater detail, after initializing the retry counts, step S13, high speed HS retries are initiated, at step S14.

When the secondary bus is not in use, the primary bus is carrying a 1553 message and the number of retries is less than the defined number, step S15, the HS-1553 message is transmitted on the secondary bus, step S16, and the HS count is incremented at step S17. When a GBT is received, step S18, the procedure ends (see “DONE”). When GBT-NOT (no message) is received, step S19, the procedure returns to S14 to attempt another retry based on the conditions existing at that time. Alternatively, at step S14, when: an MS-1553 message is being transmitted on the primary channel; the high speed retry count is greater than the defined number of high speed retries to be attempted on the primary bus; and the last MS-1553 message was sent on the primary bus, the terminal transmits at HS on the secondary bus similar to step S16. Steps S17 and S18 (or S19 and S14) follow in a like manner.

If: there is no MS-1553 traffic on the primary bus; the number of retries attempted is less than the defined number of retries; MS-1553 traffic is detected on the secondary bus is equal to or greater than the defined number of retries on the secondary bus; and the last detected MS-1553 transmission was on the secondary bus, step S20, then HS transmission is attempted on the primary bus, step S20, and the number of retries for HS attempts to transmit on the primary is incremented, step S21. If a GBT flag is detected, step S22, the procedure is completed (see “DONE”).

If no GBT flag is received, step S23, the procedure returns to step S14 and ends, at step S24 when all attempts at retries of HS-1553 on both the primary and secondary buses have equaled the defined amount of tries (see “DONE”).

If the high speed retries attempted according to FIG. 6, for example, are unsuccessful, then the HP-1553 terminal has the option of retrying the message at the concurrent mode bit rate (40 Mbps). The assumption is that there is a fault condition that is reducing the received signal level (and in turn the SNR), or there is increased noise on the bus, or there is a need to coexist with MS-1553 on the same bus (most likely due to a fault condition).

Concurrent mode retries also follow the least recently used (LRU) bus algorithm and as such need to consider MS-1553 activity in selecting which bus to issue the retries on. Retries will first be attempted on the least recently used (in terms of MS-1553 activity) bus until the maximum low speed retry count has been reached. Once the maximum low speed retry count has been reached, retries will be attempted on the most recently used bus.

MS-1553 activity is ignored when selecting a bus to transmit the HP-1553 signal on since the bit rate has been reduced to a level that should reliably support concurrent MS-1553 and HP-1553. However, the rationale for maintaining the LRU algorithm is that avoiding concurrent MS-1553 and HP-1553 will result in a larger SNR for the HP-1553 transmission and in turn a lower bit error rate.

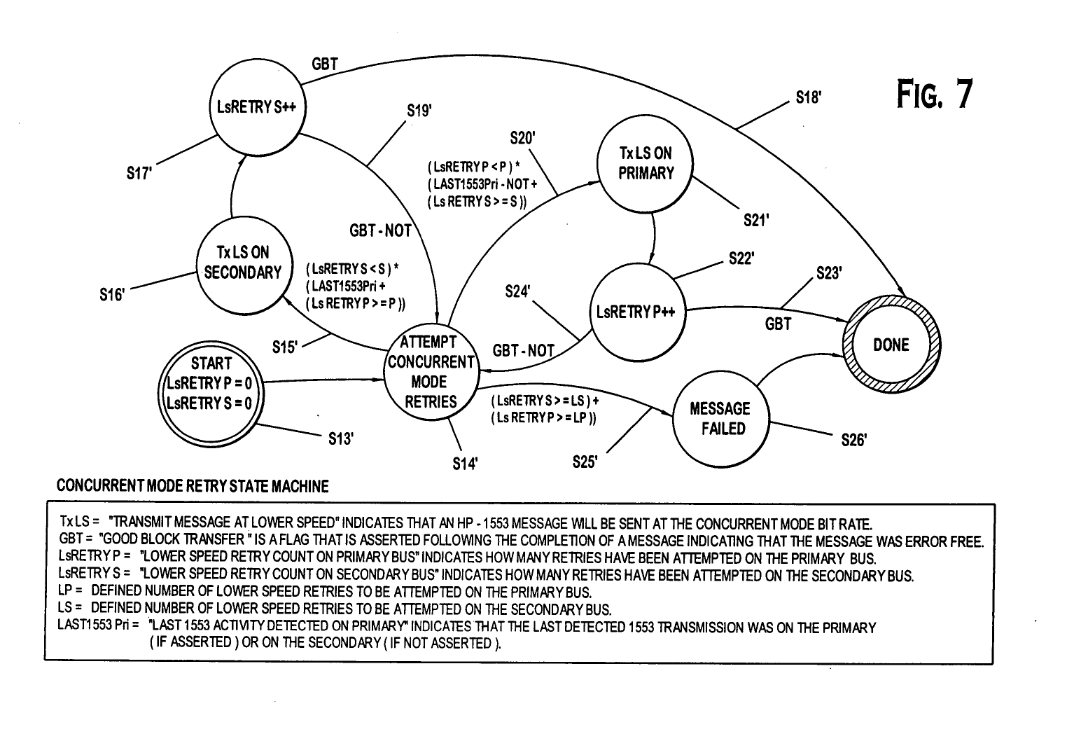

The number of retries to be attempted on each bus is an adjustable parameter. It should be noted that the number of retries may be zero in which case no retries will be attempted. The concurrent mode retry algorithm is summarized in the state machine shown in FIG. 7, which is substantially the same as the state machine of FIG. 6 except that low speed retries are attempted in a concurrent bus mode and the rules are substantially the same and the steps have been identified with a “prime.” However, note that when the low speed (LS) retries on the primary and secondary buses reach their defined limits, a “message failed” indication is provided at step S25.

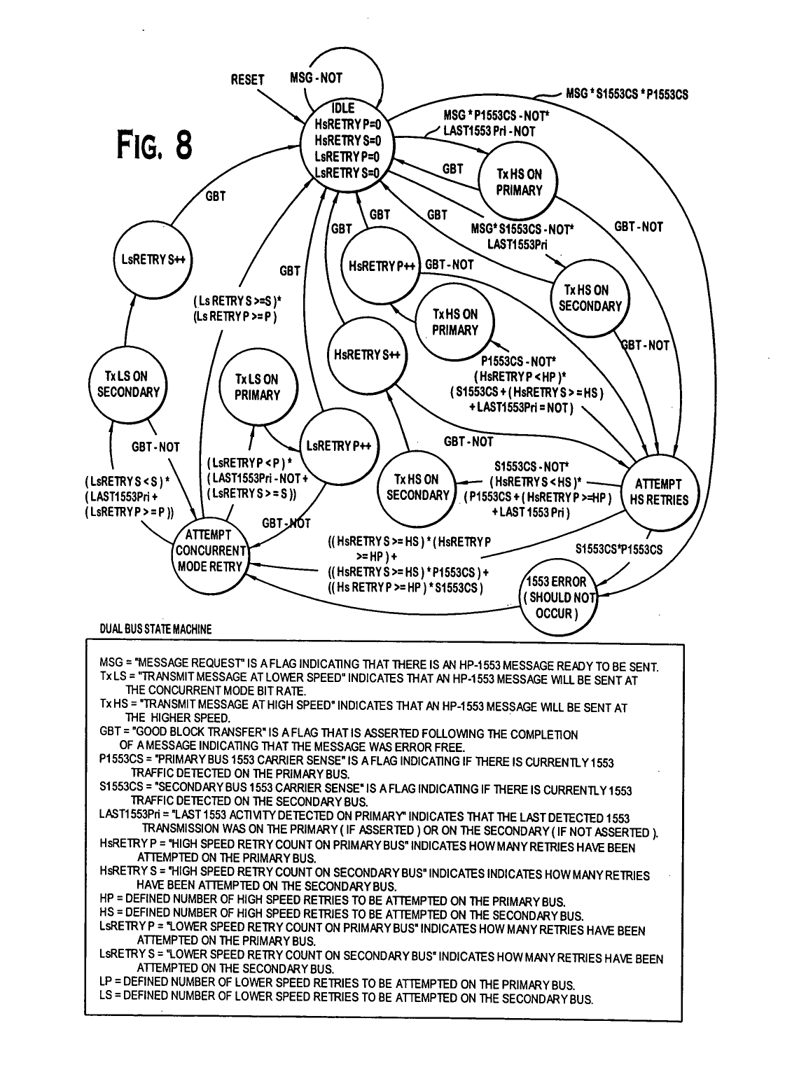

The complete algorithm for dual bus mode with error recovery is illustrated in FIG. 8 wherein the state diagram of FIGS. 6 and 7 are combined into one state diagram.

Summarizing, the HS-1553 terminal will utilize the least recently used bus at high speed and will attempt a programmable number of retries at high speed. If the high speed retries fail, then a programmable number of retries will be attempted at the degraded concurrent mode bit rate.

The ability to add high bandwidth communication channels to existing MIL-STD-1553 networks such that they are transparent to legacy 1553 equipment has significant implications in military avionics applications, especially with regards to adding new capabilities to existing systems, such as aging aircraft.

The methods described herein significantly improve the overall performance of a MIL-STD-1553 based broadband system. The unique use of MIL-STD-1553's dual standby redundant architecture provides higher data rates without sacrificing reliability.

It should be noted that the present invention is not limited to use in MS 1553 systems but may be used to provide simultaneous transmission in any dual channel system in which it is desired to enhance system operating speed without sacrificing error rate.

What is claimed is:

1. A method for use by a terminal which communicates messages at at least one of a high speed (HS) and a low speed (LS) over a pair of buses typically identified as a primary and a secondary bus, the method comprising, said terminal:
a) monitoring said buses to detect an LS communication; and
b) placing a high speed HS communication on that bus which is not carrying an LS speed communication.

2. The method of claim 1 further comprising, said terminal:
monitoring the bus carrying the HS message for an acknowledgment that the HS message was received responsive to sending of the HS message; and
repeating step (b) when no acknowledgment is received.

3. The method of claim 2 further comprising, said terminal:
accumulating a count of a number of times the HS message has been sent without receipt of an acknowledgment; and
terminating attempts to send the HS message when a given accumulation count is reached.

4. The method of claim 3 further comprising, said terminal:
returning to an operating state in readiness for sending a new message when an acknowledge is received prior to reaching said given accumulation count.

5. The method of claim 3 further comprising, said terminal:
generating an intermediate speed (IS) message having a speed greater than an LS message and less than an HS message;
multiplexing the IS message with an LS message when attempts to send an HS message have reached said given accumulation count and no acknowledge has been received; and
sending the multiplexed IS and LS messages on one of said buses.

6. The method of claim 5 further comprising:
coupling receivers for respectively receiving an LS message and an IS message to said one of said buses each of which demultiplex said multiplexed messages.

7. The method of claim 5 further comprising said terminal:
accumulating a count of a number of times the multiplexed IS and LS messages have been sent without receipt of an acknowledgment; and
returning to an operating state in readiness for handling a new communication when an acknowledge is received prior to reaching said given accumulation count.

8. The method of claim 7 further comprising, said terminal:
accumulating a count of a number of times the multiplexed IS and LS messages have been sent without receipt of an acknowledgment; and
generating a message failure indication when said given accumulated count is reached prior to receipt of an acknowledge.

9. The method of claim 1 wherein step (b) further comprises:
providing the HS communication with a preamble to identify a frequency change to a receiver terminal intended to receive the said HS communication.

10. A method for use by a terminal which sends messages at least one of a high speed (HS), a low speed (LS) and an intermediate speed (IS) over a pair of buses typically identified as a primary and a secondary bus where HS>IS>LS, the method comprising, said terminal:
a) detecting a fault condition on one of said buses;
b) multiplexing an IS message with an LS message; and
c) sending the multiplexed messages on that bus which is free of said fault condition.

11. The method of claim 10 further comprising:
coupling receivers for respectively receiving an LS message and an IS message to said one of said buses each of which demultiplex said multiplexed messages.

12. The method of claim 10 wherein step (b) further comprises:
providing the HS communication with a preamble to identify a frequency change to a receiver terminal intended to receive the said HS communication.

13. A method for use by a terminal which sends messages at at least one of a high speed (HS) and a low speed (LS) over a pair of buses typically identified as a primary and a secondary bus, the method comprising, said terminal:
a) monitoring said buses to detect an LS message; and
b) determining which of the buses is a least recent used (LRU) bus for an LS message based on step (a); and
c) sending an HS message on the bus which is not the LRU bus for carrying an LS message.

14. The method of claim 10 further comprising, said terminal:
selecting an IS message speed which reduces a likelihood of interference from said LS message as compared with said HS messages.

15. The method of claim 14 further comprising, said terminal:
selecting an HS speed of the order of 200 Mbps, and IS speed of the order of 40 Mbps and an LS speed of 1 Mbps.

16. Apparatus for use by a terminal which communicates messages at at least one of a high speed (HS) and a low speed (LS) over a pair of buses typically identified as a primary and a secondary bus, comprising:
means for monitoring said buses to detect an LS communication; and
means for placing a high speed HS communication on that bus which is not carrying an LS speed communication.

17. The apparatus of claim 16 further comprising:
means for monitoring the bus carrying the HS message for an acknowledgment that the HS message was received responsive to sending of the HS message; and
means for repeating operation of said means for placing when no acknowledgment is received.

18. The apparatus of claim 17 further comprising:
means for accumulating a count of a number of times the HS message has been sent without receipt of an acknowledgment; and
means for terminating attempts to send the HS message when a given accumulation count is reached.

19. The apparatus of claim 18 further comprising:
means for returning to an operating state in readiness for sending a new message when an acknowledge is received prior to reaching said given accumulation count.

20. The apparatus of claim 18 further comprising:
means for generating an intermediate speed (IS) message having a speed greater than an LS message and less than an HS message;
means for multiplexing the IS message with an LS message when HS attempts to send an HS message have reached said given accumulation count and no acknowledge has been received; and
means for sending the multiplexed IS and LS messages on one of said buses.

21. The apparatus of claim 20 further comprising:
means for accumulating a count of a number of times the multiplexed IS and LS messages have been sent without receipt of an acknowledgment; and
means for returning said apparatus to an operating state in readiness for handling a new communication when an acknowledge is received prior to reaching said given accumulation count.

22. The apparatus of claim 21 further comprising:
means for accumulating a count of a number of times the multiplexed IS and LS messages have been sent without receipt of an acknowledgment; and
means for generating a message failure indication when said given accumulated count is reached prior to receipt of an acknowledge.

23. Apparatus for use by a terminal which sends messages at at least one of a high speed (HS), a low speed (LS) and an intermediate speed (IS) over a pair of buses typically identified as a primary and a secondary bus where HS>IS>LS, comprising:
means for detecting a fault condition on one of said buses;
means for multiplexing an IS message with an LS message; and
means for sending the multiplexed messages on that bus which is free of said fault condition.

24. The apparatus of claim 23 further comprising:
receivers for respectively receiving an LS message and an IS message coupled to said bus which is free of said fault condition to thereby demultiplex said multiplexed messages.

25. The apparatus of claim 23 further comprising:
means for providing the HS communication with a preamble for identifying a frequency change.

26. The apparatus of claim 25 further comprising:
said receiver having means for receiving a message undergoing a frequency change responsive to said preamble.

27. Apparatus for use by a terminal which sends messages at at least one of a high speed (HS) and a low speed (LS) over a pair of buses typically identified as a primary and a secondary bus, comprising:
means for monitoring said buses to detect an LS message; and
means for determining which of the buses is a least recent used (LRU) bus for an LS message based on said means for monitoring; and
means for sending an HS message on the bus which is not the LRU bus for carrying an LS message.

28. The apparatus of claim 23 further comprising:
means for selecting an IS message speed which reduces a likelihood of interference from said LS message as compared with said HS messages.

29. The apparatus of claim 28 further comprising:
means for selecting an HS speed of the order of 200 Mbps, and IS speed of the order of 40 Mbps and an LS speed of 1 Mbps.
